(19) United States
(12) Patent Application Publication
(10) Pub. No.: US 2023/0370921 A1
(43) Pub. Date: Nov. 16, 2023

(54) Method And Apparatus For Reducing Inter-RAT Measurements For Reduced Capability User Equipment In Mobile Communications

(71) Applicant: MediaTek Inc., Hsinchu City (TW)

(72) Inventors: Yun-Hsuan Chang, Hsinchu City (TW); Chun-Pin Chen, Hsinchu City (TW)

(21) Appl. No.: 18/144,852

(22) Filed: May 9, 2023

Related U.S. Application Data
(60) Provisional application No. 63/341,436, filed on May 13, 2022.

(51) Int. Cl. H04W 36/08; H04W 36/00; H04W 36/36

(52) U.S. Cl. CPC H04W 36/08; H04W 36/0085; H04W 36/0061; H04W 36/36

(57) ABSTRACT

Various solutions for reducing inter-radio access technology (inter-RAT) measurements for reduced capability (RedCap) user equipment (UE) with respect to UE and network apparatus in mobile communications are described. An apparatus may receive a neighbor cell information from a first RAT. The apparatus may determine whether a neighbor cell of the neighbor cell information supports RedCap UE. The apparatus may perform a measurement on the neighbor cell in an event that the neighbor cell supports the RedCap UE. The apparatus may skip the measurement on the neighbor cell in an event that the neighbor cell does not support the RedCap UE.

### CROSS REFERENCE TO RELATED PATENT APPLICATION(S)

The present disclosure is part of a non-provisional application claiming the priority benefit of U.S. Patent Application No. 63/341,436, filed 13 May 2022, the content of which herein being incorporated by reference in its entirety.

### TECHNICAL FIELD

The present disclosure is generally related to mobile communications and, more particularly, to reducing inter-radio access technology (inter-RAT) measurements for reduced capability (RedCap) user equipment (UE) with respect to UE and network apparatus in mobile communications.

### BACKGROUND

Unless otherwise indicated herein, approaches described in this section are not prior art to the claims listed below and are not admitted as prior art by inclusion in this section.

In 3rd Generation Partnership Project (3GPP) Technical Specification (TS) 36.331, it defines the inter-RAT mobility procedures between Evolved Universal Terrestrial Radio Access (E-UTRA)/4^{th} Generation (4G) network and New Radio (NR)/5^{th} Generation (5G) network. When the UE is in a radio resource control (RRC) idle or inactive mode, the UE may perform a cell reselection procedure to transit between the E-UTRA network and the NR network. When the UE is in an RRC connected mode, the UE may perform a handover procedure to transit between the E-UTRA network and the NR network.

In 3GPP NR Release-17, a new type of RedCap UE/device is introduced with reduced capabilities. RedCap enables Internet of Things (loT) devices with reduced capabilities to connect to the internet via 5G networks. These RedCap devices are less complex, less costly, and more power efficient than conventional 5G devices like smartphones. For example, a RedCap UE may only support narrower bandwidth (e.g., 20 MHz) compared to a regular NR UE and/or is equipped with less multiple-input multiple-output (MIMO) antennas. For a RedCap UE, it can only connect to an NR cell with RedCap capability. For a multi-mode UE supporting RedCap in LTE mode, the UE should follow the NR neighbor cell information provided by the network side to measure NR neighbor cells. But if a RedCap UE measures an NR cell that doesn't support RedCap, it will cause unnecessary NR cell measurements. The RedCap UE will waste power and time for performing such measurements.

Accordingly, how to avoid waste of power and time becomes an important issue in the newly developed wireless communication network. Therefore, there is a need to provide proper schemes to reduce unnecessary cell measurements for a RedCap UE.

### SUMMARY

The following summary is illustrative only and is not intended to be limiting in any way. That is, the following summary is provided to introduce concepts, highlights, benefits and advantages of the novel and non-obvious techniques described herein. Select implementations are further described below in the detailed description. Thus, the following summary is not intended to identify essential features of the claimed subject matter, nor is it intended for use in determining the scope of the claimed subject matter.

One objective of the present disclosure is propose schemes, concepts, designs, systems, methods and apparatus pertaining to reducing inter-RAT measurements for RedCap UE in mobile communications. It is believed that the above-described issue would be avoided or otherwise alleviated by implementing one or more of the proposed schemes described herein.

In one aspect, a method may involve an apparatus receiving a neighbor cell information from a first RAT. The method may also involve the apparatus determining whether a neighbor cell of the neighbor cell information supports RedCap UE. The method may further involve the apparatus performing a measurement on the neighbor cell in an event that the neighbor cell supports the RedCap UE. The method may further involve the apparatus skipping the measurement on the neighbor cell in an event that the neighbor cell does not support the RedCap UE.

In one aspect, an apparatus may comprise a transceiver which, during operation, wirelessly communicates with at least one network node. The apparatus may also comprise a processor communicatively coupled to the transceiver. The processor, during operation, may perform operations comprising receiving, via the transceiver, a neighbor cell information from a first RAT. The processor may also perform operations comprising determining whether a neighbor cell of the neighbor cell information supports RedCap UE. The processor may further perform operations comprising performing, via the transceiver, a measurement on the neighbor cell in an event that the neighbor cell supports the RedCap UE. The processor may further perform operations comprising skipping the measurement on the neighbor cell in an event that the neighbor cell does not support the RedCap UE.

It is noteworthy that, although description provided herein may be in the context of certain radio access technologies, networks and network topologies such as Long-Term Evolution (LTE), LTE-Advanced, LTE-Advanced Pro, 5th Generation (5G), New Radio (NR), Internet-of-Things (IoT) and Narrow Band Internet of Things (NB-IoT), Industrial Internet of Things (IIoT), and 6th Generation (6G), the proposed concepts, schemes and any variation(s)/derivative(s) thereof may be implemented in, for and by other types of radio access technologies, networks and network topologies. Thus, the scope of the present disclosure is not limited to the examples described herein.

### BRIEF DESCRIPTION OF THE DRAWINGS

The accompanying drawings are included to provide a further understanding of the disclosure and are incorporated in and constitute a part of the present disclosure. The drawings illustrate implementations of the disclosure and, together with the description, serve to explain the principles of the disclosure. It is appreciable that the drawings are not necessarily in scale as some components may be shown to be out of proportion than the size in actual implementation in order to clearly illustrate the concept of the present disclosure.

FIG. 1 is a diagram depicting an example scenario under schemes in accordance with implementations of the present disclosure.

FIG. 2 is a diagram depicting an example process under schemes in accordance with implementations of the present disclosure.

FIG. 3 is a diagram depicting an example process under schemes in accordance with implementations of the present disclosure.

FIG. 4 is a diagram depicting an example process under schemes in accordance with implementations of the present disclosure.

FIG. 5 is a diagram depicting an example process under schemes in accordance with implementations of the present disclosure.

FIG. 6 is a block diagram of an example communication system in accordance with an implementation of the present disclosure.

FIG. 7 is a flowchart of an example process in accordance with an implementation of the present disclosure.

### DETAILED DESCRIPTION OF PREFERRED IMPLEMENTATIONS

Detailed embodiments and implementations of the claimed subject matters are disclosed herein. However, it shall be understood that the disclosed embodiments and implementations are merely illustrative of the claimed subject matters which may be embodied in various forms. The present disclosure may, however, be embodied in many different forms and should not be construed as limited to the exemplary embodiments and implementations set forth herein. Rather, these exemplary embodiments and implementations are provided so that description of the present disclosure is thorough and complete and will fully convey the scope of the present disclosure to those skilled in the art. In the description below, details of well-known features and techniques may be omitted to avoid unnecessarily obscuring the presented embodiments and implementations.

### Overview

Implementations in accordance with the present disclosure relate to various techniques, methods, schemes and/or solutions pertaining to reducing inter-RAT measurements for RedCap UE with respect to user equipment and network apparatus in mobile communications. According to the present disclosure, a number of possible solutions may be implemented separately or jointly. That is, although these possible solutions may be described below separately, two or more of these possible solutions may be implemented in one combination or another.

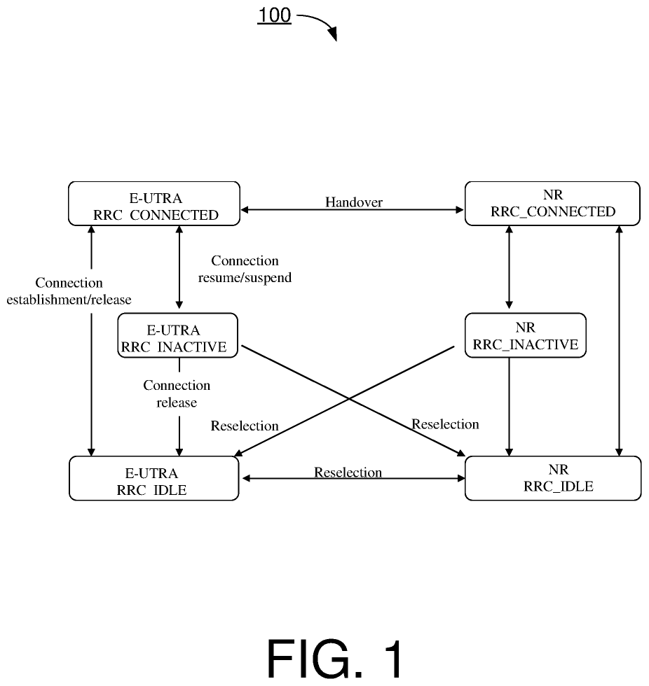

FIG. 1 illustrates an example scenario 100 under schemes in accordance with implementations of the present disclosure. Scenario 100 involves at least one UE and a plurality of network nodes, which may be a part of a wireless communication network (e.g., an LTE network, a 5G/NR network, an loT network or a 6G network). Scenario 100 illustrates the mobility procedures between E-UTRA and NR for UE states and state transitions. A UE is in RRC_CONNECTED when an RRC connection has been established or in RRC_INACTIVE when an RRC connection is suspended. If this is not the case, i.e., no RRC connection is established, the UE is in RRC_IDLE state. When the UE is in E-UTRA RRC IDLE mode or E-UTRA RRC_INACTIVE mode, the UE may perform a cell reselection procedure to transit to NR RRC_IDLE mode. When the UE is in E-UTRA RRC CONNECTED mode, the UE may perform a handover procedure to transit to NR RRC_CONNECTED mode.

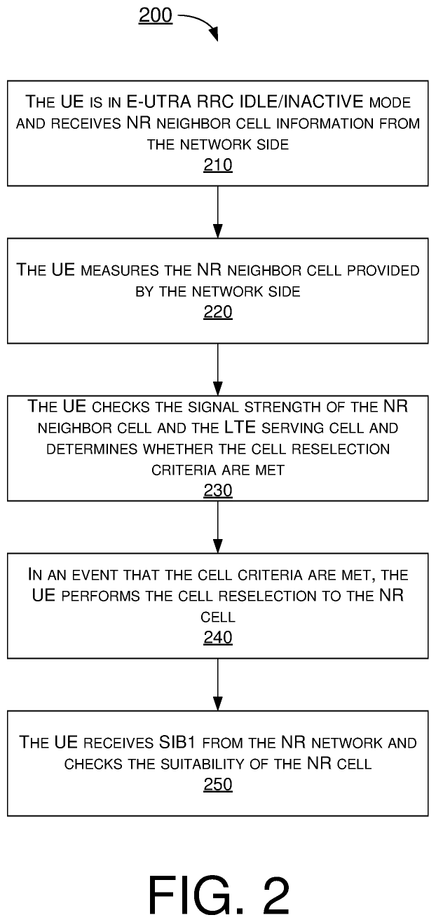

FIG. 2 illustrates an example process 200 in accordance with an implementation of the present disclosure. Process 200 involves at least one UE and a plurality of network nodes, which may be a part of a wireless communication network (e.g., an LTE network, a 5G/NR network, an loT network or a 6G network). Process 200 illustrates the cell reselection procedure from E-UTRA to NR. Process 200 may begin at block 210.

At 210, when the UE is in E-UTRA RRC IDLE mode or E-UTRA RRC INACTIVE mode, the UE may receive the NR neighbor cell information (e.g., NR neighbor cell list) from the network side. The UE may have two possible sources of the NR neighbor cell list. For example, the UE may receive MeasIdleConfig containing measldleCarrierListNR in RRCconnectionrelease message. Alternatively, the UE may receive CarrierFreqListNR from LTE system information block24 (SIB24) in the system broadcast information. Process 200 may proceed from 210 to 220.

At 220, the UE may be configured to perform measurements for the NR neighbor cell provided in the NR neighbor cell list. Process 200 may proceed from 220 to 230.

At 230, the UE may check the signal strength of the NR neighbor cell and the LTE serving cell and determine whether the cell reselection criteria are met. Process 200 may proceed from 230 to 240.

At 240, in an event that the cell reselection criteria are met, the UE may perform the cell reselection to the NR cell. Process 200 may proceed from 240 to 250.

At 250, after reselection to the NR cell, the UE may be able to receive SIB1 from the NR network and check the suitability of the NR cell.

Specifically, the UE may check the suitability of the NR cell by determining whether the NR cell supports RedCap capability. The UE may check whether the information element (IE) intraFreqReselectionRedCap is indicated in NR SIB1. In a case that the received SIB1 contains the IE intraFreqReselectionRedCap, it means that the NR cell supports RedCap capability. The RedCap UE is allowed to camp on the NR cell. In a case that the received SIB1 does not comprise the IE intraFreqReselectionRedCap, it means that the NR cell does not support RedCap capability. The RedCap UE is not allowed to camp on the NR cell.

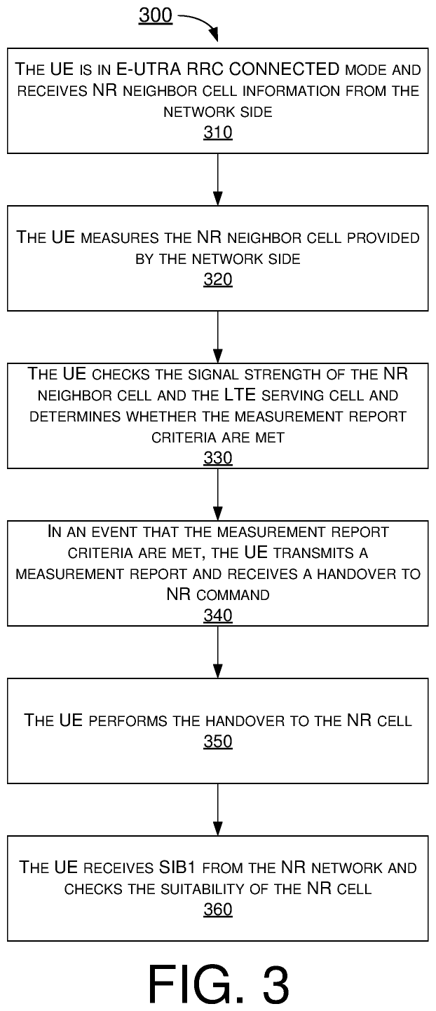

FIG. 3 illustrates an example process 300 in accordance with an implementation of the present disclosure. Process 300 involves at least one UE and a plurality of network nodes, which may be a part of a wireless communication network (e.g., an LTE network, a 5G/NR network, an loT network or a 6G network). Process 300 illustrates the handover procedure from E-UTRA to NR. Process 300 may begin at block 310.

At 310, when the UE is in E-UTRA RRC CONNECTED mode, the UE may receive the NR neighbor cell information (e.g., measurement request/measurement object) from the network side. For example, the UE may receive the NR neighbor cell list from MeasObjectNR IE inside RRCConnectionReconfiguration message. Process 300 may proceed from 310 to 320.

At 320, the UE may be configured to perform measurements for the NR neighbor cell provided in the NR neighbor cell list. Process 300 may proceed from 320 to 330.

At 330, the UE may check the signal strength of the NR neighbor cell and the LTE serving cell and determine whether the measurement report criteria are met. Process 300 may proceed from 330 to 340.

At 340, in an event that the measurement report criteria are met, the UE may transmit a measurement report of the NR neighbor cell to the network side. Then, the network side may transmit a handover to NR command to the UE. The UE may receive the handover to NR command from the network side. Process 300 may proceed from 340 to 350.

At 350, after receiving the handover to NR command, the UE may perform the handover to the NR cell. Process 300 may proceed from 350 to 360.

At 360, after handover to the NR cell, the UE may be able to receive SIB1 from the NR network and check the suitability of the NR cell.

Similarly, the UE may check the suitability of the NR cell by determining whether the NR cell supports RedCap capability. The UE may check whether the IE intraFreqReselectionRedCap is indicated in NR SIB1. In a case that the received SIB1 contains the IE intraFreqReselectionRedCap, it means that the NR cell supports RedCap capability. The RedCap UE is allowed to camp on the NR cell. In a case that the received SIB1 does not comprise the IE intraFreqReselectionRedCap, it means that the NR cell does not support RedCap capability. The RedCap UE is not allowed to camp on the NR cell.

For a RedCap UE, it can only connect to an NR cell with RedCap capability which is indicated in NR SIB1 with IE intraFreqReselectionRedCap. However, according to the procedures illustrated in FIG. 2 and FIG. 3, before the UE can receive NR SIB1 form the NR cell, the UE needs to follow the NR neighbor cell information provided by the network side to measure NR neighbor cells and perform the cell reselection or handover to the NR cell if some criteria are met. In other words, in order to receive SIB1 from the NR cell, the UE must perform the cell measurements and transit to the NR cell first. The UE has no idea whether an NR cell supports RedCap capability without acquiring SIB1 from the NR cell. In some scenarios, after performing the cell measurements and transiting to the NR cell, the UE may find that the NR cell does not support RedCap capability (i.e., the NR cell is a non-RedCap capable NR cell). The suitability check will be failed if the NR cell does not support RedCap capability. Then, the UE needs to move/transit back to the LTE cell. This will cause a waste in power and time and unnecessary ping-pong effect between the two networks.

In view of the above, the present disclosure proposes several schemes pertaining to reducing inter-RAT measurements for RedCap UE with respect to UE and network apparatus in mobile communications. According to the schemes of the present disclosure, a checking scheme will be introduced for determining whether an NR cell supports RedCap capability before performing cell measurements and transiting to an NR cell. The UE or service provider may maintain a database for recording whether an NR cell supports RedCap capability. Whenever the UE needs to measure an NR cell, the UE may acquire the database first to check whether an NR cell supports RedCap capability. In an event that an NR cell supports RedCap capability, the UE may perform measurements for the NR cell and cell reselect/handover to the NR cell. In an event that an NR cell does not support RedCap capability, the UE may skip cell measurements for the NR cell to save power and time. Accordingly, the UE is able to avoid unnecessary cell measurements and transitions. The power management and radio resource usage for the RedCap UE will be more efficient.

Specifically, the UE may be configured to receive a neighbor cell information from a first RAT. The UE may determine whether a neighbor cell of the neighbor cell information supports RedCap UE. In an event that the neighbor cell supports the RedCap UE, the UE may perform a measurement on the neighbor cell. In an event that the neighbor cell does not support the RedCap UE, the UE may skip the measurement on the neighbor cell.

In some implementations, the UE may determine whether the neighbor cell supports the RedCap according to a database. The database may comprise at least one of a RedCap unavailable list, a RedCap available list and a RedCap availability database.

In some implementations, the UE may receive an SIB (e.g., SIB1) or a MIB from a second RAT. The UE may determine whether the neighbor cell supports the RedCap UE according to the SIB/MIB. The UE may store a determination result (e.g., capability information of the neighbor cell) in the database. For example, in an event that the UE camps on an NR cell, the UE may receive an SIB or master information block (MIB) from the NR cell to determine whether the NR cell supports the RedCap UE. The UE may also check whether the NR cell is recorded in the database. In an event that there is no information about the NR cell, or the stored information is not correct, the UE may add/store the NR cell in the database or update the stored information in the database for the NR cell.

In some implementations, the first RAT may comprise an LTE or 4G network. The second RAT may comprise an NR or 5G network. The schemes proposed in the present disclosure may also be appliable to other wireless communication networks.

In some implementations, when the UE is in an idle mode or inactive mode, the UE may receive a neighbor cell list from a serving cell. The UE may determine whether a target cell of the neighbor cell list supports RedCap UE according to the database. In an event that the target cell supports RedCap UE, the UE may perform a cell reselection to the target cell. In an event that the target cell does not support RedCap UE, the UE may determine not to measure the target cell to avoid unnecessary cell measurements and cell reselection/handover.

In some implementations, when the UE is in a connected mode, the UE may receive a measurement configuration (e.g., measurement request/measurement object) from a serving cell. The UE may determine whether a target cell of the neighbor cell list supports RedCap UE according to the database. In an event that the target cell supports RedCap UE, the UE may perform a handover to the target cell. In an event that the target cell does not support RedCap UE, the UE may determine not to measure the target cell.

In some implementations, the UE may determine whether the neighbor cell is in the database. In an event that the neighbor cell is not in the database, the UE may perform a measurement on the neighbor cell. This is because in an event that the neighbor cell is not in the database, the UE has no information about whether the neighbor cell supports RedCap UE. Therefore, the UE still need to measure the neighbor cell first and determine if it can reselect/handover to the neighbor cell.

In some implementations, in an event that the neighbor cell is not in the database, or a capability information of the neighbor cell in the database is not correct, the UE may update the database after acquiring the capability information (e.g., acquiring SIB1) of the neighbor cell.

In some implementations, the database may be maintained by the UE or by a service provider (e.g., UE manufacturers or operators). For example, a UE manufacturer may maintain an NR cell RedCap availability database which stores whether NR cells support RedCap UE or not. When the UE connects to LTE with data service, the UE may download the RedCap availability database for nearby cells from cloud and store it in its internal database. When the UE at LTE mode receives NR neighbor cells provided by the network, UE may query the database to know whether the NR cells support RedCap UE or not. The UE can use the NR cell information retrieved from the database to determine whether to measure those NR cells or not. The UE may also update the latest NR cell information to the cloud in an event that the UE finds the information is mismatch/incorrect to help update the database.

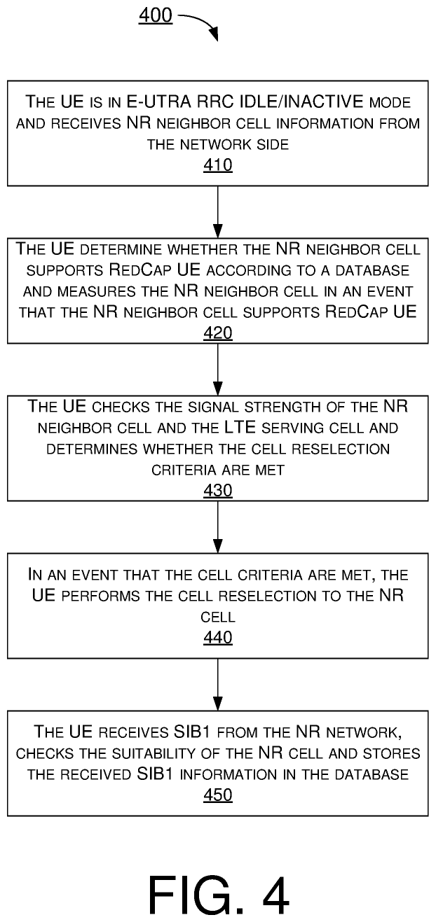

FIG. 4 illustrates an example process 400 in accordance with an implementation of the present disclosure. Process 400 involves at least one UE and a plurality of network nodes, which may be a part of a wireless communication network (e.g., an LTE network, a 5G/NR network, an loT network or a 6G network). Process 400 illustrates the improved cell reselection procedure from E-UTRA to NR. Process 400 may begin at block 410.

At 410, when the UE is in E-UTRA RRC IDLE mode or E-UTRA RRC INACTIVE mode, the UE may receive the NR neighbor cell information (e.g., NR neighbor cell list) from the network side. The UE may receive the NR neighbor cell list from an RRC message or system information. For example, the UE may receive MeasIdleCon fig containing measldleCarrierListNR in RRCconnectionrelease message. Alternatively, the UE may receive CarrierFreqListNR from LTE system information block24 (SIB24) in the system broadcast information. Process 400 may proceed from 410 to 420.

At 420, the UE may determine whether the NR neighbor cell supports RedCap UE according to the database. For example, the UE may check whether the NR neighbor cell exists in a RedCap unavailable list. In an event that the NR neighbor cell is in the RedCap unavailable list (i.e., the NR neighbor cell does not support RedCap UE), the UE may determine not to measure the NR neighbor cell to avoid unnecessary cell measurements and cell reselection. In an event that the NR neighbor cell is not in the RedCap unavailable list (e.g., the NR neighbor cell supports RedCap UE), the UE may perform measurements for the NR neighbor cell provided in the NR neighbor cell list. Process 400 may proceed from 420 to 430.

At 430, the UE may check the signal strength of the NR neighbor cell and the LTE serving cell and determine whether the cell reselection criteria are met. Process 400 may proceed from 430 to 440.

At 440, in an event that the cell reselection criteria are met, the UE may perform the cell reselection to the NR cell. Process 400 may proceed from 440 to 450.

At 450, after reselection to the NR cell, the UE may be able to receive SIB1 from the NR network. The UE may check the contents of SIB1 to check the suitability of the NR cell. In an event that the NR cell is suitable (e.g., the NR cell supports RedCap UE), the UE may stay in the NR cell. In an event that the NR cell is not suitable (e.g., the NR cell does not support RedCap UE), the UE may move back to the LTE cell. The UE may further store the received SIB1 information in the database. For example, the UE may check whether the capability information of the NR cell is in the database and store the received capability information of the NR cell in the database in an event that there is no data for the NR cell. Alternatively, the UE may check whether the capability information of the NR cell is correct and update the capability information of the NR cell in the database in an event that the capability information of the NR cell is not correct or mismatch with the database.

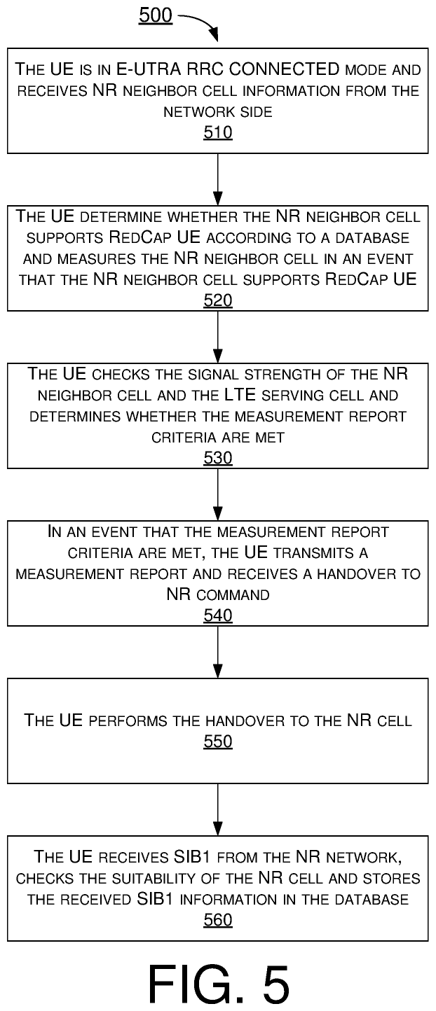

FIG. 5 illustrates an example process 500 in accordance with an implementation of the present disclosure. Process 500 involves at least one UE and a plurality of network nodes, which may be a part of a wireless communication network (e.g., an LTE network, a 5G/NR network, an loT network or a 6G network). Process 500 illustrates the improved handover procedure from E-UTRA to NR. Process 500 may begin at block 510.

At 510, when the UE is in E-UTRA RRC CONNECTED mode, the UE may receive the NR neighbor cell information (e.g., measurement request/measurement object) from the network side. For example, the UE may receive the NR neighbor cell list from MeasObjectNR IE inside RRCConnectionReconfiguration message. Process 500 may proceed from 510 to 520.

At 520, the UE may determine whether the NR neighbor cell supports RedCap UE according to the database. For example, the UE may check whether the NR neighbor cell exists in a RedCap unavailable list. In an event that the NR neighbor cell is in the RedCap unavailable list (i.e., the NR neighbor cell does not support RedCap UE), the UE may determine not to measure the NR neighbor cell to avoid unnecessary cell measurements and cell reselection. In an event that the NR neighbor cell is not in the RedCap unavailable list (e.g., the NR neighbor cell supports RedCap UE), the UE may perform measurements for the NR neighbor cell provided in the NR neighbor cell list. Process 500 may proceed from 520 to 530.

At 530, the UE may check the signal strength of the NR neighbor cell and the LTE serving cell and determine whether the measurement report criteria are met. Process 500 may proceed from 530 to 540.

At 540, in an event that the measurement report criteria are met, the UE may transmit a measurement report of the NR neighbor cell to the network side. Then, the network side may transmit a handover to NR command to the UE. The UE may receive the handover to NR command from the network side. Process 500 may proceed from 540 to 550.

At 550, after receiving the handover to NR command, the UE may perform the handover to the NR cell. Process 500 may proceed from 550 to 560.

At 560, after handover to the NR cell, the UE may be able to receive SIB1 from the NR network. The UE may check the contents of SIB1 to check the suitability of the NR cell. In an event that the NR cell is suitable (e.g., the NR cell supports RedCap UE), the UE may stay in the NR cell. In an event that the NR cell is not suitable (e.g., the NR cell does not support RedCap UE), the UE may move back to the LTE cell. The UE may further store the received SIB1 information in the database. For example, the UE may check whether the capability information of the NR cell is in the database and store the received capability information of the NR cell in the database in an event that there is no data for the NR cell. Alternatively, the UE may check whether the capability information of the NR cell is correct and update the capability information of the NR cell in the database in an event that the capability information of the NR cell is not correct or mismatch with the database.

In some implementations, the UE may record the capability information in the database for the cells it camped on. In NR idle/inactive mode or connected mode, in an event that a RedCap UE finds that an NR cell does not support RedCap UE according to the received SIB1/MI6 of the NR cell, the UE may store the NR cell in a RedCap unavailable list or a RedCap availability database. Alternatively, in an event that a RedCap UE finds that an NR cell supports RedCap UE according to the received SIB1/MI6 of the NR cell, the UE may store the NR cell in a RedCap available list or a RedCap availability database.

In some implementations, after receiving the NR neighbor cell information from the network side, the UE may find that there is no capability information for the NR neighbor cell in the database. Since the UE cannot determine whether the NR neighbor cell supports RedCap UE, the UE may still need to perform measurements for the NR neighbor cell provided in the NR neighbor cell list. The UE may check the signal strength of the NR neighbor cell and the LTE serving cell and perform cell reselection to the NR cell in an event that the cell reselection criteria are met. Then, the UE may try to receive SIB1/MIB of the NR cell to know whether the NR cell supports RedCap UE or not by checking the existence of intraFreqReselectionRedcapAllowed-r17 in SIB1. In an event that RedCap UE is not supported by the NR cell (e.g., no intraFreqReselectionRedcapAllowed-r17 indicated in SIB1), the UE may add the NR cell to the database (e.g., RedCap unavailable list).

In some implementations, the network side may indicate whether an NR cell supports RedCap by other IEs or messages. For example, for an idle mode, LTE SIB24 may contain NR frequencies and NR neighbouring cells relevant for cell re-selection. It is possible to add an IE to indicate whether an NR cell/frequency list supports RedCap in the way similar to IE highSpeedCarrierNR-r16/nr-FreqNeighHSDN-CellList-r17 which indicates NR frequency/cell list for high speed dedicated network. For a dedicate cell list for UE to measure in RRC idle mode, it is possible to add IE to indicated RedCap supportability in NR carrier/cell in MeasIdleCarrierNR-r16/measCellListNR-r16. For a connected mode, it is possible to add IE in NR measurement object to indicate whether an NR frequency/cell supports RedCap. When the UE receives a measurement configuration, the UE can determine whether to measure the RedCap supportable cell only or not base on the UE capability. For a connect mode, another possible implementation is to add a bit in feature set for the UE to indicate “NR RedCap only” to let the network know that the UE supports only RedCap mode in NR. Then, the network should assign NR measurement object base on the UE capability.

### Illustrative Implementations

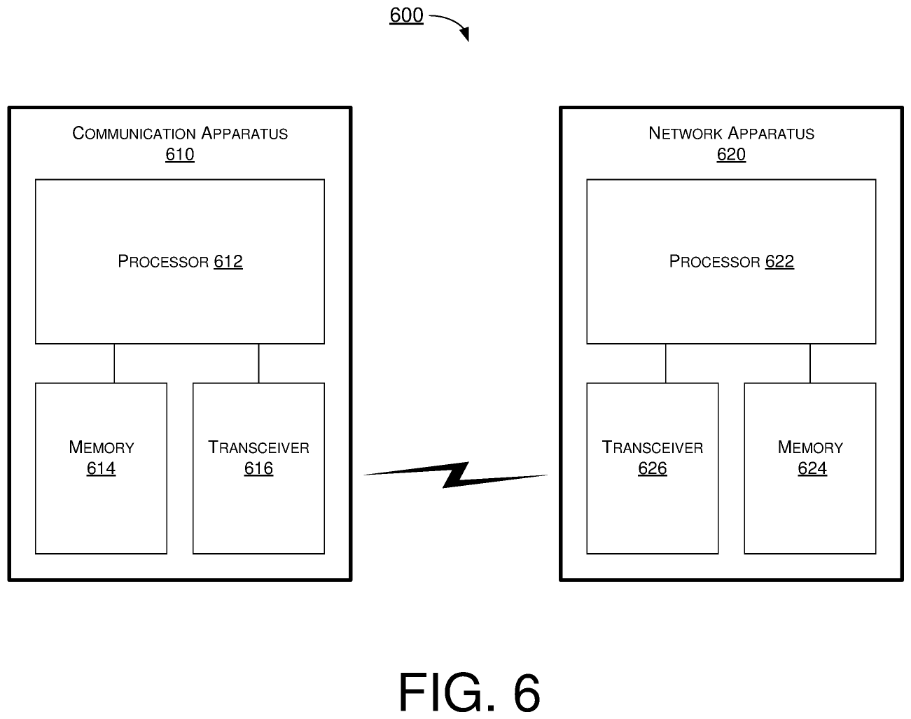

FIG. 6 illustrates an example communication system 600 having at least an example apparatus 610 and an example apparatus 620 in accordance with an implementation of the present disclosure. Each of apparatus 610 and apparatus 2620 may perform various functions to implement schemes, techniques, processes and methods described herein pertaining to reducing inter-RAT measurements for RedCap UE in mobile communications, including the various schemes described above with respect to various proposed designs, concepts, schemes, systems and methods described above, including processes 200, 300, 400 and 500, as well as process 700 described below.

Each of apparatus 610 and apparatus 620 may be a part of an electronic apparatus, which may be a network apparatus or a UE, such as a portable or mobile apparatus, a wearable apparatus, a vehicular device or a vehicle, a wireless communication apparatus or a computing apparatus. For instance, each of apparatus 610 and apparatus 620 may be implemented in a smartphone, a smart watch, a personal digital assistant, an electronic control unit (ECU) in a vehicle, a digital camera, or a computing equipment such as a tablet computer, a laptop computer or a notebook computer. Each of apparatus 610 and apparatus 620 may also be a part of a machine type apparatus, which may be an loT apparatus such as an immobile or a stationary apparatus, a home apparatus, a roadside unit (RSU), a wire communication apparatus or a computing apparatus. For instance, each of apparatus 610 and apparatus 620 may be implemented in a smart thermostat, a smart fridge, a smart door lock, a wireless speaker or a home control center. When implemented in or as a network apparatus, apparatus 610 and/or apparatus 620 may be implemented in an eNodeB in an LTE, LTE-Advanced or LTE-Advanced Pro network or in a gNB or TRP in a 5G network, an NR network or an loT network.

In some implementations, each of apparatus 610 and apparatus 620 may be implemented in the form of one or more integrated-circuit (IC) chips such as, for example and without limitation, one or more single-core processors, one or more multi-core processors, one or more complex-instruction-set-computing (CISC) processors, or one or more reduced-instruction-set-computing (RISC) processors. In the various schemes described above, each of apparatus 610 and apparatus 620 may be implemented in or as a network apparatus or a UE. Each of apparatus 610 and apparatus 2620 may include at least some of those components shown in FIG. 6 such as a processor 612 and a processor 622, respectively, for example. Each of apparatus 610 and apparatus 620 may further include one or more other components not pertinent to the proposed scheme of the present disclosure (e.g., internal power supply, display device and/or user interface device), and, thus, such component(s) of apparatus 610 and apparatus 620 are neither shown in FIG. 6 nor described below in the interest of simplicity and brevity.

In one aspect, each of processor 612 and processor 622 may be implemented in the form of one or more single-core processors, one or more multi-core processors, or one or more CISC or RISC processors. That is, even though a singular term “a processor” is used herein to refer to processor 612 and processor 622, each of processor 612 and processor 622 may include multiple processors in some implementations and a single processor in other implementations in accordance with the present disclosure. In another aspect, each of processor 612 and processor 622 may be implemented in the form of hardware (and, optionally, firmware) with electronic components including, for example and without limitation, one or more transistors, one or more diodes, one or more capacitors, one or more resistors, one or more inductors, one or more memristors and/or one or more varactors that are configured and arranged to achieve specific purposes in accordance with the present disclosure. In other words, in at least some implementations, each of processor 612 and processor 622 is a special-purpose machine specifically designed, arranged and configured to perform specific tasks including those pertaining to reducing inter-RAT measurements for RedCap UE in mobile communications in accordance with various implementations of the present disclosure.

In some implementations, apparatus 610 may also include a transceiver 616 coupled to processor 612. Transceiver 616 may be capable of wirelessly transmitting and receiving data. In some implementations, transceiver 616 may be capable of wirelessly communicating with different types of wireless networks of different radio access technologies (RATs). In some implementations, transceiver 616 may be equipped with a plurality of antenna ports (not shown) such as, for example, four antenna ports. That is, transceiver 616 may be equipped with multiple transmit antennas and multiple receive antennas for multiple-input multiple-output (MIMO) wireless communications. In some implementations, apparatus 620 may also include a transceiver 626 coupled to processor 622. Transceiver 626 may include a transceiver capable of wirelessly transmitting and receiving data. In some implementations, transceiver 626 may be capable of wirelessly communicating with different types of UEs/wireless networks of different RATs. In some implementations, transceiver 626 may be equipped with a plurality of antenna ports (not shown) such as, for example, four antenna ports. That is, transceiver 626 may be equipped with multiple transmit antennas and multiple receive antennas for MIMO wireless communications.

In some implementations, apparatus 610 may further include a memory 614 coupled to processor 612 and capable of being accessed by processor 212 and storing data therein. In some implementations, apparatus 620 may further include a memory 624 coupled to processor 622 and capable of being accessed by processor 622 and storing data therein. Each of memory 614 and memory 624 may include a type of random-access memory (RAM) such as dynamic RAM (DRAM), static RAM (SRAM), thyristor RAM (T-RAM) and/or zero-capacitor RAM (Z-RAM). Alternatively, or additionally, each of memory 614 and memory 624 may include a type of read-only memory (ROM) such as mask ROM, programmable ROM (PROM), erasable programmable ROM (EPROM) and/or electrically erasable programmable ROM (EEPROM). Alternatively, or additionally, each of memory 614 and memory 624 may include a type of non-volatile random-access memory (NVRAM) such as flash memory, solid-state memory, ferroelectric RAM (FeRAM), magnetoresistive RAM (MRAM) and/or phase-change memory. Alternatively, or additionally, each of memory 614 and memory 624 may include a UICC.

Each of apparatus 610 and apparatus 620 may be a communication entity capable of communicating with each other using various proposed schemes in accordance with the present disclosure. For illustrative purposes and without limitation, a description of capabilities of apparatus 610, as a UE, and apparatus 620, as a network node (e.g., terrestrial network node or non-terrestrial network node) of a wireless network, is provided below.

Under certain proposed schemes in accordance with the present disclosure with respect to reducing inter-RAT measurements for RedCap UE in mobile communications, processor 612 of apparatus 610, implemented in or as a UE, may receive, via transceiver 616, a neighbor cell information from a first RAT. Processor 612 may determine whether a neighbor cell of the neighbor cell information supports RedCap UE. Processor 612 may perform, via transceiver 616, a measurement on the neighbor cell in an event that the neighbor cell supports the RedCap UE. Processor 612 may skip the measurement on the neighbor cell in an event that the neighbor cell does not support the RedCap UE.

In some implementations, in determining whether the neighbor cell supports the RedCap UE, processor 612 may determine whether the neighbor cell supports the RedCap according to a database. The database may comprise at least one of a RedCap unavailable list, a RedCap available list and RedCap availability database.

In some implementations, processor 612 may receive, via transceiver 616, a SIB from a second RAT. Processor 612 may determine whether the neighbor cell supports the RedCap UE according to the SIB. Processor 612 may further store a determination result in the database.

In some implementations, the first RAT may comprise an LTE or 4G network. The second RAT may comprise an NR or 5G network.

In some implementations, processor 612 may receive, via transceiver 616, a neighbor cell list in an idle or inactive mode. Processor 612 may determine whether a target cell of the neighbor cell list supports the RedCap UE according to a database. Processor 612 may perform a cell reselection to the target cell in an event that the target cell supports the RedCap.

In some implementations, processor 612 may receive, via transceiver 616, a measurement configuration in a connected mode. Processor 612 may determine whether a target cell of the measurement configuration supports the RedCap UE according to a database. Processor 612 may perform a handover to the target cell in an event that the target cell supports the RedCap.

In some implementations, processor 612 may determine whether the neighbor cell is in the database. Processor 612 may perform, via transceiver 616, a measurement on the neighbor cell in an event that the neighbor cell is not in the database.

In some implementations, processor 612 may update the database in an event that the neighbor cell is not in the database, or a capability of the neighbor cell is not correct.

In some implementations, the database may be maintained in a cloud or provided by a service provider.

### Illustrative Processes

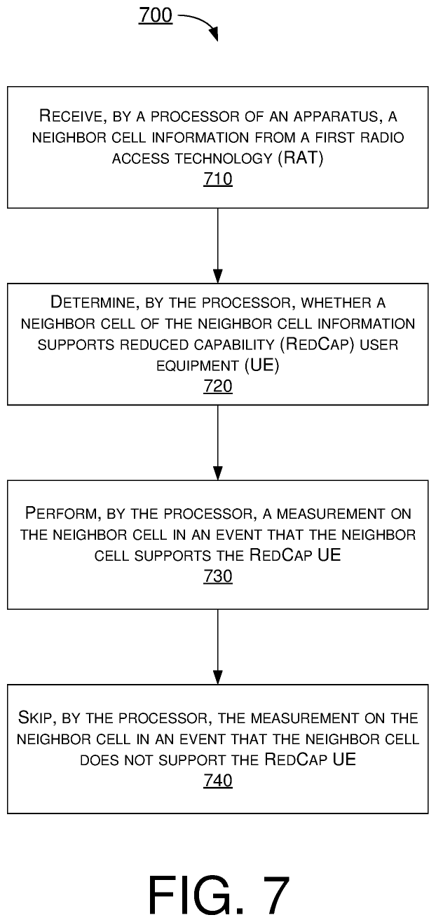

FIG. 7 illustrates an example process 700 in accordance with an implementation of the present disclosure. Process 700 may represent an aspect of implementing various proposed designs, concepts, schemes, systems and methods described above, whether partially or entirely, including those described above. More specifically, process 700 may represent an aspect of the proposed concepts and schemes pertaining to reducing inter-RAT measurements for RedCap UE in mobile communications. Process 700 may include one or more operations, actions, or functions as illustrated by one or more of blocks 710, 720, 730 and 740. Although illustrated as discrete blocks, various blocks of process 700 may be divided into additional blocks, combined into fewer blocks, or eliminated, depending on the desired implementation. Moreover, the blocks/sub-blocks of process 700 may be executed in the order shown in FIG. 7 or, alternatively in a different order. Furthermore, one or more of the blocks/sub-blocks of process 700 may be executed iteratively. Process 700 may be implemented by or in apparatus 610 and apparatus 620 as well as any variations thereof. Solely for illustrative purposes and without limiting the scope, process 700 is described below in the context of apparatus 610 as a UE and apparatus 620 as a communication entity such as a network node or base station (e.g., terrestrial network node or non-terrestrial network node) of a network. Process 700 may begin at block 710.

At 710, process 700 may involve processor 612 of apparatus 610, receiving a neighbor cell information from a first RAT. Process 700 may proceed from 710 to 720.

At 720, process 700 may involve processor 612 determining whether a neighbor cell of the neighbor cell information supports RedCap UE. Process 700 may proceed from 720 to 730.

At 730, process 700 may involve processor 612 performing a measurement on the neighbor cell in an event that the neighbor cell supports the RedCap UE. Process 700 may proceed from 730 to 740.

At 740, process 700 may involve processor 612 skipping the measurement on the neighbor cell in an event that the neighbor cell does not support the RedCap UE.

In some implementations, in determining whether the neighbor cell supports the RedCap UE, process 700 may involve processor 612 determining whether the neighbor cell supports the RedCap according to a database.

In some implementations, process 700 may involve processor 612 receiving a SIB from a second RAT. Process 700 may involve processor 612 determining whether the neighbor cell supports the RedCap UE according to the SIB. Process 700 may involve processor 612 storing a determination result in the database.

In some implementations, process 700 may involve processor 612 receiving a neighbor cell list in an idle or inactive mode. Process 700 may involve processor 612 determining whether a target cell of the neighbor cell list supports the RedCap UE according to a database. Process 700 may involve processor 612 performing a cell reselection to the target cell in an event that the target cell supports the RedCap.

In some implementations, process 700 may involve processor 612 receiving a measurement configuration in a connected mode. Process 700 may involve processor 612 determining whether a target cell of the measurement configuration supports the RedCap UE according to a database. Process 700 may involve processor 612 performing a handover to the target cell in an event that the target cell supports the RedCap.

In some implementations, process 700 may involve processor 612 determining whether the neighbor cell is in the database. Process 700 may involve processor 612 performing a measurement on the neighbor cell in an event that the neighbor cell is not in the database.

In some implementations, process 700 may involve processor 612 updating the database in an event that the neighbor cell is not in the database, or a capability of the neighbor cell is not correct.

### Additional Notes

The herein-described subject matter sometimes illustrates different components contained within, or connected with, different other components. It is to be understood that such depicted architectures are merely examples, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

Further, with respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

Moreover, it will be understood by those skilled in the art that, in general, terms used herein, and especially in the appended claims, e.g., bodies of the appended claims, are generally intended as “open” terms, e.g., the term “including” should be interpreted as “including but not limited to,” the term “having” should be interpreted as “having at least,” the term “includes” should be interpreted as “includes but is not limited to,” etc. It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to implementations containing only one such recitation, even when the same claim includes the introductory phrases “one or more” or “at least one” and indefinite articles such as “a” or “an,” e.g., “a” and/or “an” should be interpreted to mean “at least one” or “one or more;” the same holds true for the use of definite articles used to introduce claim recitations. In addition, even if a specific number of an introduced claim recitation is explicitly recited, those skilled in the art will recognize that such recitation should be interpreted to mean at least the recited number, e.g., the bare recitation of “two recitations,” without other modifiers, means at least two recitations, or two or more recitations. Furthermore, in those instances where a convention analogous to “at least one of A, B, and C, etc.” is used, in general such a construction is intended in the sense one having skill in the art would understand the convention, e.g., “a system having at least one of A, B, and C” would include but not be limited to systems that have A alone, B alone, C alone, A and B together, A and C together, B and C together, and/or A, B, and C together, etc. In those instances where a convention analogous to “at least one of A, B, or C, etc.” is used, in general such a construction is intended in the sense one having skill in the art would understand the convention, e.g., “a system having at least one of A, B, or C” would include but not be limited to systems that have A alone, B alone, C alone, A and B together, A and C together, B and C together, and/or A, B, and C together, etc. It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

From the foregoing, it will be appreciated that various implementations of the present disclosure have been described herein for purposes of illustration, and that various modifications may be made without departing from the scope and spirit of the present disclosure. Accordingly, the various implementations disclosed herein are not intended to be limiting, with the true scope and spirit being indicated by the following claims.

What is claimed is:

1. A method, comprising:
receiving, by a processor of an apparatus, a neighbor cell information from a first radio access technology (RAT);
determining, by the processor, whether a neighbor cell of the neighbor cell information supports reduced capability (RedCap) user equipment (UE);
performing, by the processor, a measurement on the neighbor cell in an event that the neighbor cell supports the RedCap UE; and
skipping, by the processor, the measurement on the neighbor cell in an event that the neighbor cell does not support the RedCap UE.

2. The method of claim 1, wherein the determining comprises determining whether the neighbor cell supports the RedCap according to a database.

3. The method of claim 2, wherein the database comprises at least one of a RedCap unavailable list, a RedCap available list and a RedCap availability database.

4. The method of claim 1, further comprising:
receiving, by the processor, a system information block (SIB) from a second RAT;
determining, by the processor, whether the neighbor cell supports the RedCap UE according to the SIB; and
storing, by the processor, a determination result in the database.

5. The method of claim 4, wherein the first RAT comprises a Long-Term Evolution (LTE) or 4G network, and wherein second RAT comprises a New Radio (NR) or 5G network.

6. The method of claim 1, further comprising:
receiving, by the processor, a neighbor cell list in an idle or inactive mode;
determining, by the processor, whether a target cell of the neighbor cell list supports the RedCap UE according to a database; and
performing, by the processor, a cell reselection to the target cell in an event that the target cell supports the RedCap.

7. The method of claim 1, further comprising:
receiving, by the processor, a measurement configuration in a connected mode;
determining, by the processor, whether a target cell of the measurement configuration supports the RedCap UE according to a database; and
performing, by the processor, a handover to the target cell in an event that the target cell supports the RedCap.

8. The method of claim 2, further comprising:
determining, by the processor, whether the neighbor cell is in the database; and
performing, by the processor, a measurement on the neighbor cell in an event that the neighbor cell is not in the database.

9. The method of claim 2, further comprising:
updating, by the processor, the database in an event that the neighbor cell is not in the database, or a capability of the neighbor cell is not correct.

10. The method of claim 2, wherein the database is maintained in a cloud or provided by a service provider.

11. An apparatus, comprising:
a transceiver which, during operation, wirelessly communicates with at least one network node; and
a processor communicatively coupled to the transceiver such that, during operation, the processor performs operations comprising:
receiving, via the transceiver, a neighbor cell information from a first radio access technology (RAT);
determining whether a neighbor cell of the neighbor cell information supports reduced capability (RedCap) user equipment (UE);
performing, via the transceiver, a measurement on the neighbor cell in an event that the neighbor cell supports the RedCap UE; and
skipping the measurement on the neighbor cell in an event that the neighbor cell does not support the RedCap UE.

12. The apparatus of claim 11, wherein, in determining whether the neighbor cell supports the RedCap UE, the processor determines whether the neighbor cell supports the RedCap according to a database.

13. The apparatus of claim 12, wherein the database comprises at least one of a RedCap unavailable list, a RedCap available list and RedCap availability database.

14. The apparatus of claim 11, wherein, during operation, the processor further performs operations comprising:
receiving, via the transceiver, a system information block (SIB) from a second RAT;
determining whether the neighbor cell supports the RedCap UE according to the SIB; and
storing a determination result in the database.

15. The apparatus of claim 14, wherein the first RAT comprises a Long-Term Evolution (LTE) or 4G network, and wherein second RAT comprises a New Radio (NR) or 5G network.

16. The apparatus of claim 11, wherein, during operation, the processor further performs operations comprising:
receiving, via the transceiver, a neighbor cell list in an idle or inactive mode;
determining whether a target cell of the neighbor cell list supports the RedCap UE according to a database; and
performing a cell reselection to the target cell in an event that the target cell supports the RedCap.

17. The apparatus of claim 11, wherein, during operation, the processor further performs operations comprising:
receiving, via the transceiver, a measurement configuration in a connected mode;
determining whether a target cell of the measurement configuration supports the RedCap UE according to a database; and
performing a handover to the target cell in an event that the target cell supports the RedCap.

18. The apparatus of claim 12, wherein, during operation, the processor further performs operations comprising:
determining whether the neighbor cell is in the database; and
performing, via the transceiver, a measurement on the neighbor cell in an event that the neighbor cell is not in the database.

19. The apparatus of claim 12, wherein, during operation, the processor further performs operations comprising:
updating the database in an event that the neighbor cell is not in the database, or a capability of the neighbor cell is not correct.

20. The apparatus of claim 12, wherein the database is maintained in a cloud or provided by a service provider.
